(19) United States
(12) Patent Application Publication
(10) Pub. No.: US 2022/0012611 A1
(43) Pub. Date: Jan. 13, 2022

(54) METHOD AND MACHINE LEARNING MANAGER FOR HANDLING PREDICTION OF SERVICE CHARACTERISTICS

(71) Applicant: Telefonaktiebolaget LM Ericsson (publ), Stockholm (SE)

(72) Inventors: Farnaz MORADI, Stockholm (SE); Andreas JOHNSSON, Uppsala (SE)

(73) Assignee: Telefonaktiebolaget LM Ericsson (publ), Stockholm (SE)

(21) Appl. No.: 17/295,347

(22) PCT Filed: Mar. 19, 2019
(86) PCT No.: PCT/EP2019/056878

§ 371 Date: May 19, 2021

Related U.S. Application Data
(60) Provisional application No. 62/770,330, filed on Nov. 21, 2018.

(51) Int. Cl. G06N 5/04; G06N 3/08; G06N 20/20

(52) U.S. Cl. CPC G06N 5/04; G06N 20/20; G06N 3/08

(57) ABSTRACT

A method and a machine learning manager (100) for handling prediction of service characteristics using machine learning applied in a target domain (102B). A source model M_{S} used for machine learning pre-trained in a source domain (102A) is obtained, and a transfer configuration that divides the source model into a fixed first part and a non-fixed second part is selected. A target model is created by applying the selected transfer configuration on the source model so that the target model is divided into said first and second parts. The second part is then trained using observations collected in the target domain, and the target model M_{T} with the first part and the trained second part is provided for prediction of service characteristics in the target domain.

### TECHNICAL FIELD

The present disclosure relates generally to a method and a machine learning manager, for handling prediction of service characteristics using machine learning applied in a target domain.

### BACKGROUND

In the field of telecommunication, it is often of interest for network operators to ensure that communication services are executed with adequate performance and quality, particularly as perceived by end-users such as humans operating communication devices and parties controlling so-called Internet-of-Things, IoT, devices. Depending on the type of service and requirements in a service agreement or the like, a certain level of quality may be required or expected, which is sometimes regulated by a Service Level Agreement, SLA, or the like. Consequently, to fulfil SLAs and meet user expectations the network operator needs to gain control of the performance of a service when executed, and be able to obtain predictions of the performance in the future during service execution. For example, the service performance and resulting quality are typically related to latency, visual/audio reproduction and data accuracy, as experienced by the end-user.

Techniques have been developed for using Machine Learning, ML, based on a machine learning model that can predict the experienced service performance or other service characteristics at the end-users during execution, based on available observations in the communication network and infrastructure used which may for example include a wireless network with 5G infrastructure including radio base stations, data centers and network components. Even though 5G is mentioned herein as an example of a communication standard, this disclosure is not limited thereto and may be applicable for any type of communication networks, technologies and standards.

To achieve a reliable and accurate machine learning model for prediction of various service parameters, e.g. related to the performance or other characteristics of the service, the model needs to be trained based on data and observations generated in the network and infrastructure. When training a machine learning model in general, the model is continuously evaluated by applying available input values to the model to see how well a prediction generated by the model on these input values agrees with subsequent measurements and observations, which thus determines whether the model is “good” and accurate, or “bad” needing further training for improvement. Numerous techniques for machine learning as such have been described and some non-limiting examples include a neural network and the so-called random-forest model comprising a number of so-called decision trees.

The process of training a machine learning model can be computational heavy and typically requires substantial amounts of computing and processing resources, herein referred to as “resources” for short, which are typically acquired from some data centre in a cloud environment, commonly referred to as “the cloud”. In the field of cloud computing, resources for computing, processing and storing of data can be hired and used temporarily, e.g. for execution of various services in a communication network and also for machine learning operations. When an operation or task is completed, the used resources are released to become available for other operations and clients.

However, when services are executed by using cloud resources, it is very common that the usage of resources change during service execution so that the service is migrated from one set of resources to another, which could affect the service characteristics, e.g. related to performance. A service may further be executed using resources in more than one data center and the combination of cloud resources used may thus fluctuate to provide a dynamic cloud environment.

It is thus a challenge in model creation and training to maintain sufficient accuracy of a machine learning model over time, particularly in a dynamic environment such as a cloud, where the usage of resources often changes during service execution. Cloud-executed services typically rely on a virtualization layer, enabled by Virtual Machines, VMs, or containers, allowing service components to migrate between resources in different physical execution environments. Further, the resources assigned to a VM or a container may be dynamically scaled up or down, e.g. based on operator policies or user requirements. Such changes may thus reduce the accuracy of a machine learning model which has been trained and adapted for a specific system configuration and environmental condition that is no longer used. As a consequence, management functions that rely on an accurate machine learning model could be negatively affected, unless the model is updated and adapted to the new cloud condition.

Extensive measurements and data collection are usually required for acquiring enough data needed for training an accurate machine learning model. The data collection process takes time and the signaling and processing overhead associated with measurements and data collection can adversely affect the service itself and potentially co-located services as well. For certain services executed by short-lived Virtual Network Functions, VNFs, there is often not enough time to gather the data required for accurate prediction before the VNF is released. For other services, measurements needed for accurate modeling may arrive at a steady pace, but are not available from the start. In general, it takes time to collect enough data to obtain an accurate and reliable machine learning model, e.g. for performance prediction.

In recent years, a technique called “transfer learning” has been suggested to support the process of model training for performing a machine learning task, specifically in areas such as image, video and sound recognition. In traditional machine learning, each learning task is learnt “from scratch” using training data obtained from a certain domain for making predictions for data to be obtained from the same domain. However, sometimes there is not sufficient amounts of data for training in the domain of interest, in particular immediately after the service has started. In these cases, transfer learning can be used to transfer knowledge from a domain where sufficient training data is available, referred to as the source domain, to the domain of interest, referred to as the target domain, in order to improve the accuracy of the machine learning task.

However, it may still be a problem that a machine learning model trained by data generated in a source domain is not accurate enough when transferred to a target domain, and that an extensive time period is required for collecting data in the target domain for re-training the model before it becomes sufficiently accurate, e.g. to make relevant quality related predictions so as to fulfil performance requirements.

### SUMMARY

It is an object of embodiments described herein to address at least some of the problems and issues outlined above. It is possible to achieve this object and others by using a method and a machine learning manager as defined in the attached independent claims.

According to one aspect, a method which may be performed by a machine learning manager, is provided for handling prediction of service characteristics using machine learning applied in a target domain. In this the method, a source model M_{S} used for machine learning in a source domain is obtained, which source model M_{S} has been pre-trained using observations collected in the source domain. The source model M_{S} is thus adapted to conditions in the source domain and is thereby capable of predicting service characteristics in the source domain. A transfer configuration is then selected that divides the source model M_{S} into a fixed first part and a non-fixed second part.

A target model M_{T} for machine learning in the target domain is further created by applying the selected transfer configuration on the source model M_{S} so that the target model M_{T} is divided into said first part and second part. The second part of the target model M_{T} is then trained using observations collected in the target domain, while the fixed first part is kept as is in the target model M_{T}. This means basically that the source model M_{S} is transformed into the target model M_{T} which is adapted to conditions in the target domain and thus capable of predicting service characteristics in the source domain. Finally, the target model M_{T} with the first part and the trained second part, is provided as a basis for said prediction of service characteristics in the target domain.

According to another aspect, a machine learning manager is arranged to handle prediction of service characteristics using machine learning applied in a target domain. The machine learning manager is configured to obtain a source model M_{S} used for machine learning in a source domain, which source model M_{S} has been pre-trained using observations collected in the source domain. This may be accomplished by means of an obtaining module in the machine learning manager.

The machine learning manager is further configured to select a transfer configuration that divides the source model M_{S} into a fixed first part and a non-fixed second part, which may be accomplished by means of a selecting module in the machine learning manager.

The machine learning manager is also configured to create a target model M_{T} for machine learning in the target domain by applying the selected transfer configuration on the source model M_{S} so that the target model M_{T} is divided into said first part and second part, and to train said second part of the target model M_{T} using observations collected in the target domain. This may be accomplished by means of a creating module and a training module, respectively, in the machine learning manager.

The machine learning manager is also configured to provide the target model M_{T} with the first part and the trained second part, as a basis for said prediction of service characteristics in the target domain, which may be accomplished by means of a providing module in the machine learning manager.

The above method and machine learning manager may be configured and implemented according to different optional embodiments to accomplish further features and benefits, to be described below.

A computer program is also provided comprising instructions which, when executed on at least one processor in the above machine learning manager, cause the at least one processor to carry out the method described above. A carrier is also provided which contains the above computer program, wherein the carrier is one of an electronic signal, an optical signal, a radio signal, or a computer readable storage medium.

### BRIEF DESCRIPTION OF DRAWINGS

The solution will now be described in more detail by means of exemplary embodiments and with reference to the accompanying drawings, in which:

FIG. 1 is a communication overview illustrating how a machine learning manager may use a source model M_{S} for obtaining a target model M_{T} for prediction of service characteristics when a service is migrated from one data center 1 to another data center 2, according to some example embodiments

FIG. 2 is a flow chart illustrating a procedure in a machine learning manager, according to further example embodiments.

FIG. 3 is a diagram illustrating different candidate transfer configurations that may be used for training a target model, according to further example embodiments.

FIG. 4 is a schematic illustration of a neural network which may be employed for implementing the solution, according to further example embodiments.

FIG. 5 is a flow chart illustrating an example of a more detailed procedure in a machine learning manager, according to further example embodiments.

FIG. 6 is a block diagram illustrating how a machine learning manager may be structured, according to further example embodiments.

FIGS. 7A and 7B are diagrams illustrating experimental results of Normalized Mean Absolute Error, NMAE, when employing transfer learning of a neural network obtained in a source domain where different numbers of said layers are re-trained in a target domain.

### DETAILED DESCRIPTION

The solution will now be described and explained in terms of functionality in a machine learning manager which is operable to handle prediction of service characteristics using machine learning applied in a target domain, by utilizing a machine learning model that has been pre-trained using observations in a source domain. In this description, the term “data” is frequently used for short to represent any observations, measurements and samples that can be used as input for training a machine learning model.

The term “machine learning manager” used throughout this disclosure can be understood as a logical entity that may be realized in one or more physical nodes connected to one or more data centers which may include resources implemented in a central cloud and/or in one or more edge clouds. The terms source domain and target domain used herein refer to different sets of resources and/or different prediction tasks, which sets or tasks may reside in different data centers or in the same data center. Further, the resource sets or tasks may be assigned to a VM or a container in a more or less dynamic manner.

As explained above, the resources used for service execution, e.g. in a communications network or other infrastructure, may fluctuate in a dynamic manner so that the service is migrated from one domain to another, e.g. depending on availability and efficient usage of the resources. Such resource fluctuations and service migrations may occur at any time and to any extent which is subject to operation of the network and infrastructure, and in such conditions it is challenging to employ machine learning for making predictions of service characteristics since a machine learning model trained for predictions in one domain may not be very useful and accurate for predictions in another domain. In this solution it has been realized that the amount or extent of re-training a model when transfer learning is employed can be reduced and still achieving a useful and accurate target model within as short time as possible.

Even though several examples described herein relate to prediction of the performance of a service, it should be noted that these examples are also applicable for predicting other types of service characteristics and the embodiments herein are not limited in this respect. For example, the machine learning models described herein may be trained for predicting service performance to support quality control, and for other prediction tasks as well such as root-cause analysis or anomaly detection. The term “model” is frequently used herein for short to denote a machine learning model.

The embodiments herein utilize the knowledge built up by pre-training a source model herein denoted M_{S} using observations collected in a source domain, and using the source model M_{S} for making predictions in a target domain. As in the above-described transfer learning technique, the source model M_{S} is adapted to the target domain by re-training it using observations collected in the target domain, thereby transforming the source model M_{S} into a target model herein denoted M_{T}.

In the solution described herein, the time it takes to achieve an accurate and useful target model M_{T}, can be substantially reduced by selecting a transfer configuration that divides the obtained source model M_{S} into a fixed first part which will not be re-trained and a non-fixed second part that will be re-trained by observations from the target domain, and by creating the target model M_{T} to comprise said first and second parts according to the selected transfer configuration. In effect, only the non-fixed second part is trained by data from observations collected in the target domain so that the target model M_{T} becomes accurate and useful for making predictions in the target domain.

It is an advantage that the above procedure is flexible in that the transfer configuration can be freely selected depending on requirements on the model and on what data is available in the target domain and also on the type of model used. Thereby, the size and nature of the second part to be re-trained in the target domain can be suitably adapted to the above circumstances. Some examples of how the source and target models can be divided into said first and second parts will be described later below.

FIG. 1 illustrates a practical example of how the machine learning manager described herein may be implemented and operate when a service is migrated from one domain to another, in this case different data centers. In this example, a wireless communication network is serving a number of mobile users and various services are executed for the users in a physical execution environment illustrated as a source domain 102A which is comprised of resources R in a first data center. A source model M_{S} has been trained for machine learning in the source domain 102A and M_{S} is thus useful for making predictions of characteristics of a service when the service is executed in the source domain 102A.

At some point, the service execution is for some reason migrated to resources R in a second data center which effectively constitute a target domain 102B, as illustrated by a dashed arrow from 102A to 102B. Some potential reasons for migrating a service from one domain to another have been mentioned above. In order to accomplish prediction of service characteristics in the target domain 102B, the machine learning (ML) manager 100 obtains the source model M_{S} used for machine learning in the source domain 102A, and creates a target model M_{T} by transforming the source model M_{S} to become adapted to conditions in the target domain 102B.

In more detail, the target model M_{T} is created by dividing M_{S} into the above-described first and second parts according to a suitably selected transfer configuration, and by re-training the second part data using observations collected in the target domain 102B, so that target model M_{T} originating from the source model M_{S} becomes adapted and useful for making predictions in the target domain. The target model M_{T} and/or resulting predictions may then be supplied to a “client” which may be an Operations Support System (OSS) or a Business Support System (BSS) or the like associated with the communication network.

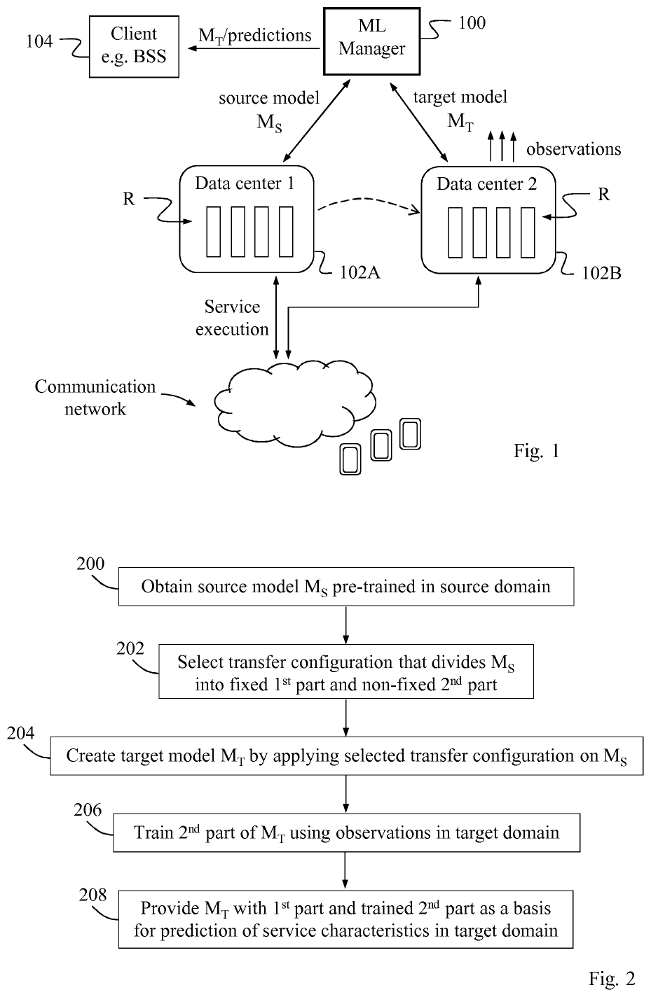

An example of how the solution may be employed in terms of actions performed by a machine learning manager such as the machine learning manager 100, is illustrated by the flow chart in FIG. 2 which will now be described with further reference to FIG. 1, although this procedure is not limited to the example of FIG. 1. FIG. 2 thus illustrates a procedure in the machine learning manager 100 for handling prediction of service characteristics using machine learning applied in a target domain. Some optional example embodiments that could be used in this procedure will also be described.

A first action 200 illustrates that the machine learning manager 100 obtains a source model M_{S} used for machine learning in a source domain 102A, which source model M_{S} has been pre-trained using observations collected in the source domain 102A. Conventional training of a machine learning model using samples and measurements in general taken in a certain domain, and using the model for making predictions in said domain, is well-known in this field and the source model M_{S} may have been pre-trained in any such conventional manner which is somewhat outside the embodiments herein. It is just assumed here that the source model M_{S} has been more or less adapted to the circumstances and conditions in the source domain 102A and that it is thus more or less useful and accurate for predicting service characteristics in the source domain 102A.

As explained above, the purpose of transfer learning is generally to take advantage of knowledge from one domain in a new domain, i.e. the source and target domains described herein. First, the model needs to be trained by observations, or data, collected from the new domain before it can provide accurate predictions in that domain, which in this solution can be made in an efficient manner as follows.

In another action 202, the machine learning manager 100 selects a transfer configuration that divides the obtained source model M_{S} into a fixed first part and a non-fixed second part. In this context, a “fixed part” of a model means that this part will basically not be trained by data from the new domain but can be used as is, while a “non-fixed part” of the model means that this part will be adapted to the new domain by re-training it by data collected from the new domain. The transfer configuration thus determines how extensive, or “large”, the fixed and non-fixed parts will be relative each other in the source model M_{S}, which is related to the type of model used. Some examples of how a transfer configuration could be defined and selected will be described later below with reference to some possible embodiments.

It should be noted that the division of the model into the first and second parts as described above should be seen as a logic division, while in practice the original source model in either of the first and second parts may be modified when transformed into the target model, e.g. by addition or deletion of layers, nodes and/or weights of a neural network, or by addition or deletion of decision trees and/or nodes of a random-forest model.

In another action 204, the machine learning manager 100 further creates a target model M_{T} for machine learning in the target domain by applying the selected transfer configuration on the source model M_{S} so that the resulting target model M_{T} is divided into said first part and second part. Some examples of how a transfer configuration could be employed will also be described later below with reference to further example embodiments.

In another action 206, the machine learning manager 100 trains, or effectively re-trains, said second part of the target model M_{T} using observations collected in the target domain 102B. As mentioned above, both the first and second parts of the source model M_{S} have already been trained using observations from the source domain 102A, and the source model M_{S} is now transformed into the target model M_{T} in the present action by “re-training” the second part using observations from the target domain 102B. Thereby, the target model M_{T} will be adapted to the circumstances and conditions in the new target domain 1028 to become useful and accurate for predicting service characteristics in the target domain 1028.

In a final action 208, the machine learning manager 100 provides the target model M_{T} with the first part and the trained second part, as a basis for said prediction of service characteristics in the target domain. This action may be performed e.g. by sending the target model M_{T} to a client 104 which is then able to use the model for predicting service characteristics in the target domain 1028. Alternatively, the machine learning manager 100 may itself, in action 208, use the target model M_{T} for predicting service characteristics in the target domain 1028, and then supply the resulting predictions to the client 104. How to realize action 208 in practice can thus be a matter of implementation.

Thanks to the above operations of selecting a transfer configuration, applying the selected transfer configuration on the target model M_{T} to be comprised of respective fixed and non-fixed first and second parts, and (re-)training only the second part using observations from the target domain 102B, it is an advantage that the time before an accurate enough machine learning model is achieved for predictions in the target domain, will be substantially shortened. Particularly as compared to training the model “from scratch” which requires a relatively large number of observations collected over time, and it may thus take considerable time before sufficient training data is available so that the model can provide accurate and useful predictions. This problem can be sidestepped by employing the procedure of FIG. 2 to accomplish an accurate model much earlier.

Another advantage is that the amount of processing resources required for training the new model will be substantially reduced since the collection of observations and the model training can be controlled, e.g. stopped, depending on how accurate the model has become. By dividing the target model M_{S} into a fixed first part and a non-fixed second part according to the selected transfer configuration as described above, the process of training the new model is also very flexible in the sense that it can be selected how much of the model to train, i.e. the flexible second part, and how much can be kept and used as is, i.e. the non-flexible first part.

The selection of transfer configuration may thus be dependent on several factors, e.g. including the amount of observations and samples that are available in the target domain, the type of model used, and also the usage and availability of processing and storing resources in the target domain, to mention a few non-limiting but illustrative examples. Thereby, the model training can easily be adapted to the current circumstances in the target domain, e.g. to minimize the time it takes and the amount of observations needed for re-training the second part.

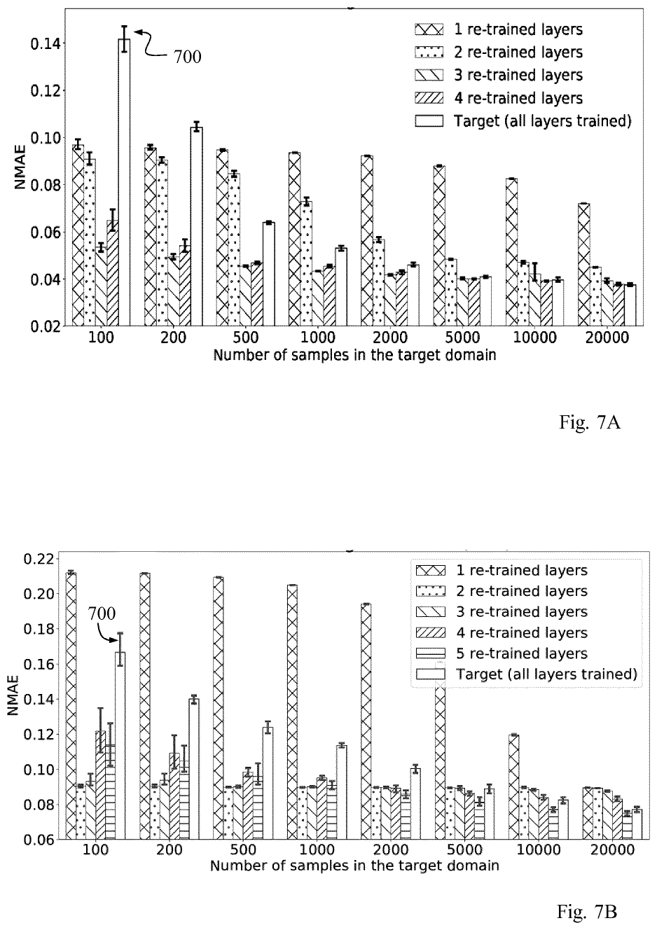

Some further examples of embodiments that may be employed in the above procedure in FIG. 2 will now be described. In one example embodiment, the above-mentioned transfer configuration may be selected based on the number of available observations in the target domain. It turns out that the larger second part that is re-trained, the shorter time and the less data may in some cases be required before the model becomes accurate. In other cases, re-training a larger part may need longer time than re-training a smaller part before an accurate model is achieved. Some measurements of model errors depending on the number of layers of a neural network in the second part and the amount of available samples in a target domain are depicted in FIGS. 7A and 7B, to be described later below.

In another example embodiment, said transfer configuration may further be selected by training the second part of the target model M_{T} according to a set of candidate transfer configurations and selecting the candidate transfer configuration that provides the most accurate target model M_{T}. In other words, each candidate transfer configuration is tested by training the second part of each target model M_{T} according to the respective candidate transfer configuration, and comparing the accuracy of the resulting target models M_{T}. In this context, a target model that is divided into first and second parts according to a candidate transfer configuration may be referred to as a candidate target model.

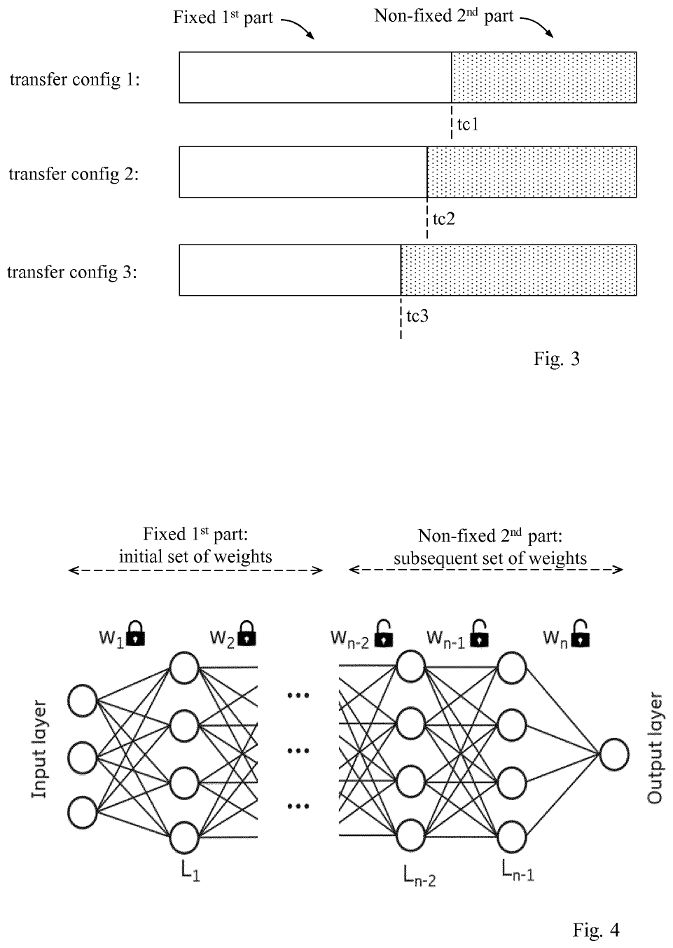

It was mentioned above that the transfer configuration basically determines how extensive the fixed and non-fixed parts are relative each other. FIG. 3 illustrates schematically how three transfer configurations tc1, tc2 and tc3 divides a machine learning model M into the fixed first part and the non-fixed second part. It can be seen that when tc1 is used, a relatively small second part of the model needs to be re-trained, as shown by a dotted part on the right side of the model, while tc2 and tc3 require re-training of increasingly larger second parts of the model.

To realize the latter embodiment of training and evaluating a set of candidate transfer configurations, these may have been predefined in advance, e.g. with respect to what type of machine learning model is used for the source and target models. It is also possible to have multiple predefined sets of candidate transfer configurations out of which one set can be selected for training depending on the current circumstances. In that case, another example embodiment may be that the set of candidate transfer configurations is selected based on the number of available observations in the target domain.

When two or more candidate transfer configurations are tested and evaluated, another example embodiment may be that the transfer configuration is selected by evaluating the candidate transfer configurations with respect to one or more predefined criteria. One such predefined criterion may e.g. be to select the transfer configuration that results in the lowest mean square error of a predicted service characteristic parameter compared to a subsequent measurement of the same parameter. In other words, another example embodiment may be that the one or more predefined criteria selects the candidate transfer configuration that provides a target model M_{T} with the highest accuracy and/or lowest error.

In another example embodiment, said source and target domains may refer to different sets of computing resources and/or different prediction tasks, which has also been explained above.

In another example embodiment, said observations collected in either of the source and target domains may include measurements and samples taken in the source and target domains, respectively.

It was mentioned above that the second part of the target model M_{T} is trained, in action 206, using observations collected in the target domain. In another example embodiment, the collection of observations in the target domain may be controlled based on the performance of the target model M_{T}. For example, the collection of observations can be gradually increased or reduced depending on the target model accuracy over time. One possibility is to gradually reduce the collection of observations as the target model becomes more and more accurate, and/or to increase the collection in case the model accuracy is deteriorated. Another example embodiment may be that the collection of observations in the target domain can even be stopped when the target model M_{T} is accurate enough. Thereby, it is not necessary to spend time and efforts to collect any further observations once the target model M_{T} is “good” enough, i.e. providing satisfactory predictions that more or less agree with the actual outcome of service characteristics.

It was mentioned above that the transfer configuration may be selected depending on, among other things, what type of machine learning model is used. In another example embodiment, the source and target models M_{S} and M_{T} may be based on a neural network where the first part of the model M_{S}, M_{T} comprises a set of initial weights in the neural network and the second part of the source model M_{S} comprises a set of subsequent weights in the neural network. A neural network is typically organized in successive levels between an input level and an output level, where each level has a number of weights for measurable parameters in a manner that is known in the field of machine learning.

FIG. 4 illustrates schematically a neural network comprised of a number of layers L₁ . . . Lₙ with respective sets of weights W₁ . . . Wₙ, where training the model basically comprises adjusting the weights so as to make the model more accurate. It is also illustrated how the latter embodiment can be implemented by selecting a transfer configuration that divides the model M_{S}, M_{T} into the first part with a set of initial fixed weights W₁, W₂ . . . which do not need to be re-trained by adjustment, as indicated by closed locks, and the second part with a set of subsequent non-fixed weights Wₙ₋₂, Wₙ₋₁, Wₙ which are to be re-trained and adjusted, as indicated by open locks. Different transfer configurations have different distributions of fixed and non-fixed levels of weights, which are also employed in the measurements shown in FIG. 7.

In another example embodiment, the source and target models M_{S} and M_{T} may alternatively comprise a random-forest model with a number of trees where the first part of the source model M_{S} comprises a first set of trees and the second part of the source model M_{S} comprises a second set of trees. In a similar manner, the first set of trees are not re-trained by adjustment while only the second set of trees will be adjusted and re-trained.

In another example embodiment, said observations may be related to performance of the service such as latency, content quality and data rate, and/or to current usage of processing and storing resources. In another example embodiment, said prediction of service characteristics in the target domain may comprise predicting whether a Service Level Agreement, SLA, has been violated in the target domain.

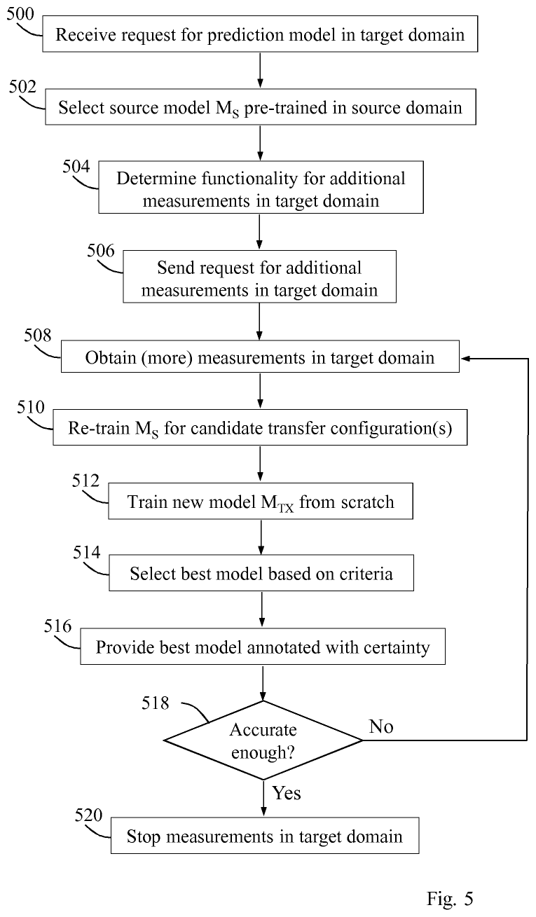

Another more detailed example of how the procedure of FIG. 2 may be implemented in practice, will now be described with reference to the flow chart in FIG. 5, likewise with further reference to FIG. 1. In this example, the following actions are performed by the machine learning manager 100:

Action 500—The machine learning manager 100 receives a request for a prediction model, e.g. from a client such as a BSS or a cloud management entity or a data center manager. The requested prediction model corresponds to the above-described target model and will be used for making predictions in a target domain. There are no or very few observations available in the target domain.

Action 502—The machine learning manager 100 selects, or requests from another entity, a suitable source model M_{S} which has been pre-trained in a source domain. This action corresponds to the above-described action 200.

Action 504—The machine learning manager 100 determines functionality for performing additional measurements in the target domain, which might be needed for model training in the target domain. For example, an ontology or database describing available measurement tools for a given service and infrastructure may be used for determining such additional measurements.

Action 506—The machine learning manager 100 sends a request to the target domain to perform the above additional measurements, or to subscribe for already ongoing measurements.

Action 508—The machine learning manager 100 more or less continuously obtains measurements made in the target domain.

Action 510—It is assumed that a target model M_{T} with a fixed first part and a non-fixed second part has been created as of action 204. The machine learning manager 100 re-trains the second part of the target model M_{T} for each possible transfer configuration, given the new measurements received from the target domain. This action corresponds to the above-described action 206. Effectively, the second part of multiple target models M_{T} are re-trained in parallel for evaluation.

Action 512—The machine learning manager 100 further trains a so-called “baseline target model” M_{TX} from scratch using only the new measurements available from the target domain.

Action 514—The machine learning manager 100 selects the best transfer configuration based on one or more criteria, (e.g. minimizing the mean square error) by evaluating and comparing the predictions from each transfer configuration to the baseline target model M_{TX}. For example, if the model is based on a neural network, the best transfer configuration may dictate that the target model M_{T} has 3 non-fixed layers of weights to be re-trained, e.g. when the number of available measurements is low, see FIG. 7.

Action 516—The machine learning manager 100 provides to the requesting client the new target model M_{T} annotated with a “certainty” of the model which reflects the amount of available samples in the target domain, and with the transfer configuration selected.

Action 518—It is checked whether the model is accurate enough.

Action 520—If yes in the previous action, the machine learning manager 100 sends a notification to the target domain to stop providing measurements therefrom.

If no in action 518, the machine learning manager 100 returns to action 508 to obtain more measurements so the target models M_{T} can be further trained and evaluated in the manner described above.

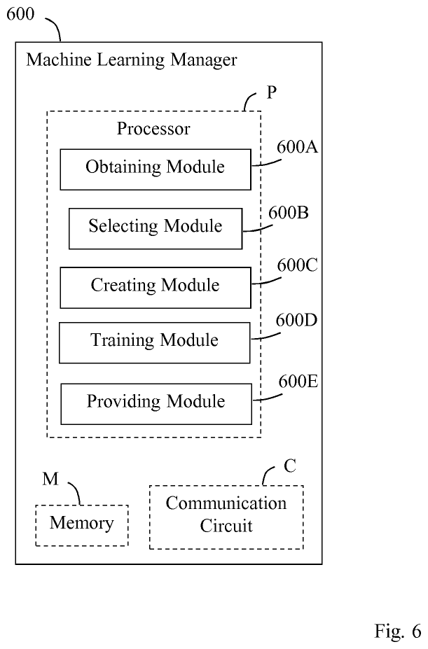

The block diagram in FIG. 6 illustrates a detailed but non-limiting example of how a machine learning manager 600 may be structured to bring about the above-described solution and embodiments thereof.

In this figure, the machine learning manager 600 may be configured to operate according to any of the examples and embodiments of employing the solution as described herein, where appropriate. The machine learning manager 600 is shown to comprise a processor “P”, a memory “M” and a communication circuit “C” with suitable equipment for transmitting and receiving information and data in the manner described herein.

The communication circuit C in the machine learning manager 600 thus comprises equipment configured for communication, such as provision of the target model M_{T} and reception of samples and measurements as said observations from the respective source and target domains, using a suitable protocol for the communication depending on the implementation. The solution is however not limited to any specific types of messages or protocols used for any of the communications mentioned herein.

The machine learning manager 600 is, e.g. by means of units, modules or the like, configured or arranged to logically perform the actions of the flow chart in FIG. 2 and at least some of the actions of the flow chart in FIG. 5, as follows.

The machine learning manager 600 is arranged to handle prediction of service characteristics using machine learning applied in a target domain. As mentioned above, the target domain may refer to a set of processing resources, e.g. located in a data center or the like, and/or to one or more specific prediction tasks which may reside in one or more data centers.

The machine learning manager 600 is configured to obtain a source model M_{S} used for machine learning in a source domain, which source model M_{S} has been pre-trained using observations collected in the source domain. The source domain may likewise refer to processing resources and/or to prediction task(s) in one or more data centers. This operation may be performed by an obtaining module 600A in the machine learning manager 600, as also illustrated in action 200. The obtaining module 600A could alternatively be named a receiving module or a model acquiring module.

The machine learning manager 600 is also configured to select a transfer configuration that divides the source model M_{S} into a fixed first part and a non-fixed second part. This operation may be performed by a selecting module 600B in the machine learning manager 600, as also illustrated in action 202. The selecting module 600B could alternatively be named a logic module or a model configuring module.

The machine learning manager 600 is further configured to create a target model M_{T} for machine learning in the target domain by applying the selected transfer configuration on the source model M_{S} so that the target model M_{T} is divided into said first part and second part. This operation may be performed by a creating module 600C in the machine learning manager 600, as also illustrated in action 204. The creating module 600C could alternatively be named an applying module.

The machine learning manager 600 is further configured to train said second part of the target model M_{T} using observations collected in the target domain. This operation may be performed by a training module 600D in the machine learning manager 600, as also illustrated in action 206. The training module 600D could alternatively be named a modelling module.

The machine learning manager 600 is further configured to provide the target model M_{T} with the first part and the trained second part, as a basis for said prediction of service characteristics in the target domain. This operation may be performed by a providing module 600E in the machine learning manager 600, as also illustrated in action 208. The providing module 600E could alternatively be named a sending or supplying module.

It should be noted that FIG. 6 illustrates various functional modules in the machine learning manager 600 and the skilled person is able to implement these functional modules in practice using suitable software and hardware equipment. Thus, the solution is generally not limited to the shown structure of the machine learning manager 600, and the functional modules therein may be configured to operate according to any of the features, examples and embodiments described in this disclosure, where appropriate.

The functional modules 600A-E described above may be implemented in the machine learning manager 600 by means of program modules of a computer program comprising code means which, when run by the processor P causes the machine learning manager 600 to perform the above-described actions and procedures. The processor P may comprise a single Central Processing Unit (CPU), or could comprise two or more processing units. For example, the processor P may include a general purpose microprocessor, an instruction set processor and/or related chips sets and/or a special purpose microprocessor such as an Application Specific Integrated Circuit (ASIC). The processor P may also comprise a storage for caching purposes.

The computer program may be carried by a computer program product in the machine learning manager 600 in the form of a memory having a computer readable medium and being connected to the processor P. The computer program product or memory M in the machine learning manager 600 thus comprises a computer readable medium on which the computer program is stored e.g. in the form of computer program modules or the like. For example, the memory M may be a flash memory, a Random-Access Memory (RAM), a Read-Only Memory (ROM) or an Electrically Erasable Programmable ROM (EEPROM), and the program modules could in alternative embodiments be distributed on different computer program products in the form of memories within the machine learning manager 600.

The solution described herein may be implemented in the machine learning manager 600 by a computer program comprising instructions which, when executed on at least one processor, cause the at least one processor to carry out the actions according to any of the above embodiments and examples, where appropriate. The solution may also be implemented at the machine learning manager 600 in a carrier containing the above computer program, wherein the carrier is one of an electronic signal, optical signal, radio signal, or computer readable storage medium.

It was mentioned above that the transfer configuration may be selected in action 202 depending on how much data or observations are available in the target domain, and that the larger second part that is re-trained, the shorter time and the less data may sometimes be required to make the model accurate. In other cases, the opposite may be true when longer time is needed to re-train a larger part than to re-train a smaller part before the model becomes accurate. Two examples of experimental results of NMAE resulting from using different numbers of re-trained layers and when different numbers of samples are available, are shown by the diagrams in FIGS. 7A and 7B. It can be seen in these diagrams that different transfer configurations, i.e. re-training different number of layers, leads to varying NMAE values which indicate how accurate the model is. The lower NMAE, the more accurate model. In FIGS. 7A and 7B, the numeral 700 denotes error bars which indicate the error or uncertainty in the measured values in terms of a variance.

The diagram in FIG. 7A contains different NMAE values resulting from using transfer configurations with 1-4 re-trained layers, respectively, of a neural network. In this example, a transfer configuration of training 3 layers generally provides the lowest NMAE when relatively few samples are available, e.g. only 200 samples. For increased number of samples, the NMAE decreases and when there are 10000 samples available, training 4 layers leads to the lowest NMAE. Further note, that the baseline target model M_{TX} of re-training all layers from scratch leads to a high NMAE, until at least 2000 samples are available in the target domain. The best transfer configuration thus depends on the number of samples available in the target domain.

The diagram in FIG. 7B contains different NMAE values resulting from using transfer configurations of re-training 1-5 layers, respectively, of a neural network. In this example, using a transfer configuration of re-training 1 layer results in the highest NMAE basically regardless of how many samples are available, while using a transfer configuration of re-training 2 layers provides the lowest NMAE when relatively few samples are available. When there are more than 2000 samples available, the best transfer configuration is to re-train 5 layers.

While the solution has been described with reference to specific exemplifying embodiments, the description is generally only intended to illustrate the inventive concept and should not be taken as limiting the scope of the solution. For example, the terms “machine learning manager”, “machine learning model”, “target domain”, “source domain”, “target model”, “source model”, “service characteristics”, “transfer configuration” and “observations” have been used throughout this disclosure, although any other corresponding entities, functions, and/or parameters could also be used having the features and characteristics described here. The solution is defined by the appended claims.

1. A method for handling prediction of service characteristics using machine learning applied in a target domain, the method comprising:
obtaining a source model MS used for machine learning in a source domain, which source model MS has been pre-trained using observations collected in the source; domain;
selecting a transfer configuration that divides the source model MS into a fixed first part and a non-fixed second part;
creating a target model MT for machine learning in the target domain by applying the selected transfer configuration on the source model MS so that the target model MT is divided into said first part and second part;
training said second part of the target model MT using observations collected in the target domain, wherein the collection of observations in the target domain is controlled based on the performance of the target model and is stopped when the target model is accurate enough; and
providing the target model MT with the first part and the trained second part, as a basis for said prediction of service characteristics in the target domain.

2. The method of claim 1, wherein said transfer configuration is selected based on the number of available observations in the target domain.

3-6. (canceled)

7. The method of claim 1, wherein said source and target domains refer to different sets of computing resources and/or different prediction tasks.

8. The method of claim 1, wherein said observations include measurements and samples taken in the source and target domains, respectively.

9-12. (canceled)

13. The method of claim 1, wherein said observations are related to performance of the service such as latency, content quality and data rate, and/or to current usage of processing and storing resources.

14. The method of claim 1, wherein said prediction of service characteristics in the target domain comprises predicting whether a Service Level Agreement has been violated in the target domain.

15. A machine learning manager arranged to handle prediction of service characteristics using machine learning applied in a target domain, wherein the machine learning manager comprises:
memory; and
processing circuitry coupled to the memory, wherein the machine learning manager is configured to:
obtain a source model MS used for machine learning in a source domain, which source model MS has been pre-trained using observations collected in the source domain;
select a transfer configuration that divides the source model MS into a fixed first part and a non-fixed second part;
create a target model MT for machine learning in the target domain by applying the selected transfer configuration on the source model MS so that the target model MT is divided into said first part and second part;
train said second part of the target model MT using observations collected in the target domain, wherein the machine learning manager is configured to control the collection of observations in the target domain based on the performance of the target model and to stop the collection of observations in the target domain when the target model is accurate enough; and
provide the target model MT with the first part and the trained second part, as a basis for said prediction of service characteristics in the target domain.

16. The machine learning manager of claim 15, wherein the machine learning manager is configured to select said transfer configuration based on the number of available observations in the target domain.

17. The machine learning manager of claim 15, wherein the machine learning manager is configured to select said transfer configuration by training the second part of the target model MT according to a set of candidate transfer configurations and by selecting the candidate transfer configuration that provides the most accurate target model MT.

18. The machine learning manager of claim 17, wherein the machine learning manager is configured to select the set of candidate transfer configurations based on the number of available observations in the target domain.

19. The machine learning manager of claim 17, wherein the machine learning manager is configured to select the transfer configuration by evaluating the candidate transfer configurations with respect to one or more predefined criteria.

20. The machine learning manager of claim 19, wherein said one or more predefined criteria is/are configured to select the candidate transfer configuration that provides a target model MT with the highest accuracy and/or lowest error.

21. The machine learning manager of claim 15, wherein said source and target domains refer to different sets of computing resources and/or different prediction tasks.

22. The machine learning manager of claim 15, wherein said observations include measurements and samples taken in the source and target domains, respectively.

23-24. (canceled)

25. The machine learning manager of claim 15, wherein the source and target models MS and MT are based on a neural network where the first part of the source model MS comprises a set of initial weights in said neural network and the second part of the source model MS comprises a set of subsequent weights in the neural network.

26. The machine learning manager of claim 15, wherein the source and target models MS and MT comprise a random-forest model with a number of trees where the first part of the source model MS comprises a first set of trees and the second part of the source model MS comprises a second set of trees.

27. The machine learning manager of claim 15, wherein said observations are related to performance of the service such as latency, content quality and data rate, and/or to current usage of processing and storing resources.

28. The machine learning manager of claim 15, wherein said prediction of service characteristics in the target domain comprises predicting whether a Service Level Agreement, SLA, has been violated in the target domain.

29. A computer program product comprising a non-transitory computer readable medium storing a computer program comprising instructions which, when executed on at least one processor, cause the at least one processor to carry out the method of claim 1.

30. (canceled)
